(19) United States
(12) Patent Application Publication
(10) Pub. No.: US 2026/0340014 A1
(43) Pub. Date: Oct. 29, 2026

(54) PARALLEL GENERATION OF RESPONSE AND REAL-TIME COMPARISON OF ARTIFICIAL INTELLIGENCE LANGUAGE MODEL OUTPUTS USING INTEGRATED PROGRAMMATIC AND SPECIALIZED GUIDED AND CONSTRAINED ARTIFICIAL INTELLIGENCE

(71) Applicant: Trilogy Enterprises, Inc., Austin, TX (US)

(72) Inventors: Arthur Michel, Brooklyn, NY (US); Benji Bizzell, Asheville, NC (US); Neeraj Gupta, Austin, TX (US)

(73) Assignee: Trilogy Enterprises, Inc., Austin, TX (US)

(21) Appl. No.: 19/390,288

(22) Filed: Nov. 14, 2025

Related U.S. Application Data
(60) Provisional application No. 63/720,178, filed on Nov. 14, 2024.
(60) Provisional application No. 63/720,179, filed on Nov. 14, 2024.

(51) Int. Cl. G06F 16/338; G06F 16/334; G06F 16/35; G06F 40/30

(52) U.S. Cl. CPC G06F 16/338; G06F 16/3347; G06F 16/35; G06F 40/30

(57) ABSTRACT

A parallel response generation and language model comparison system and process receive one or more queries through a user interface, classify the one or more queries into categories, and select appropriate prompt schemas. A prompt generator applies one or more queries to the selected schema and transmits the generated prompt to a plurality of small language models (SLMs) and a large language model (LLM). An embedding module receives responses from an output response module and generates embeddings for all responses and stores them in a vector database. The vector database calculates similarity scores between the plurality of SLMs first responses and the LLM second response using the embeddings. Additionally, a response ranker measures response times for each of the SLM by tracking the duration between the first and final tokens. The response ranker ranks first responses based on both similarity scores and response time.

### CROSS-REFERENCE TO RELATED APPLICATION(S)

This application claims the benefit under 35 U.S.C. § 119(e) and 37 C.F.R. § 1.78 of U.S. Provisional Application Nos. 63/720,178 and 63/720,179, which are incorporated by reference in their entireties.

### FIELD OF THE INVENTION

The present invention generally relates to the field of electronics, and more specifically a parallel response generation and language model comparison system and a parallel response generation and language model comparison process that facilitates real-time comparison and ranking of small language model outputs.

### DESCRIPTION OF THE RELATED ART

The rapid growth of artificial intelligence (AI) applications has created an unprecedented demand for efficient and accurate language processing systems. Organizations across industries have implemented various approaches to meet this growing demand, ranging from single Large Language Model (LLM) to distributed Small Language Model (SLM) networks. The implementations, however, face persistent challenges in balancing computational efficiency, response accuracy, and resource utilization.

A sequential SLM response without ranking attempted to obtain responses from multiple SLMs in a sequential manner. The sequence of SLM responses without ranking queried each SLM one after another, waiting for each model to complete its response before proceeding to the next. The sequential SLM approach suffered from the sequential processing, which created substantial time delays. and the sequential SLM approach lacked a quality control mechanism. This absence of quality control mechanisms meant that users could not effectively verify the accuracy and reliability of the generated responses.

Traditional AI systems employ a single LLM to handle all queries, from simple to complex tasks. This one-size-fits-all approach burdens computational resources, as the single LLM model activates the LLM full processing power even for basic requests. The LLM processes each query through billions of parameters, consuming substantial memory and processing capacity. Consequently, the user experiences noticeable delays in response times, watching and waiting while the single LLM model engages the entire neural network to generate even more straightforward answers. The inefficiencies persist as the singular LLM model devotes the same intensive computational effort to parsing a simple greeting as the singular LLM model does to analyzing complex technical documents. Organizations implementing the single LLM model approach face higher operational costs due to the constant demand for premium computational resources, regardless of the query's complexity level.

The SLM operates independently to generate responses to the queries. The SLM models use multiple SLMs working in parallel but lack any comparison mechanism against the LLM. This approach created significant challenges for maintaining consistent output quality. Without the LLM serving as a benchmark or reference point, the SLM produced highly variable responses that often fell short of desired accuracy standards. Organizations implementing the SLM found difficult to guarantee reliable performance across different types of queries. The absence of a higher-level validation mechanism left the user vulnerable to inconsistent or potentially inaccurate information, highlighting a critical gap in quality control for AI-powered response systems.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary parallel response generation and language model comparison system.

FIG. 2 depicts an exemplary parallel response generation and language model comparison process.

FIG. 3 depicts the process flow, which is an embodiment of parallel response generation and language model comparison processes.

FIG. 4 depicts a data flow, which is an embodiment of parallel response generation and language model comparison process.

FIG. 5 depicts flow from the user through the plurality of SLMs and the LLM for the ranking of responses, which is an embodiment of parallel response generation and language model comparison process.

FIG. 6 depicts the response comparison of different language models, which is an embodiment of parallel response generation and language model comparison process.

FIG. 7 depicts the performance scatter plot by a user interface, which is an embodiment of parallel response generation and language model comparison process.

FIG. 8 depicts an exemplary network environment in which the parallel response generation and language model comparison system of FIG. 1 and the parallel response generation and language model comparison process of FIG. 2 may be practiced.

FIG. 9 depicts an exemplary computer system.

### DETAILED DESCRIPTION

A parallel response generation and language model comparison system and process receive one or more queries through a user interface, classify the one or more queries into categories, and select appropriate prompt schemas. A prompt generator applies one or more queries to the selected schema and transmits the generated prompt to a plurality of small language models (SLMs) and a large language model (LLM). An embedding module receives responses from an output response module and generates embeddings for all responses and stores them in a vector database. The vector database calculates similarity scores between the plurality of SLMs first responses and the LLM second response using the embeddings. Additionally, a response ranker measures response times for each of the SLM by tracking the duration between the first and final tokens. The response ranker ranks first responses based on both similarity scores and response time.

The parallel response generation and language model comparison system offers significant advantages over prior art solutions by fundamentally solving two critical limitations of existing systems. Traditional approaches either relied solely on the LLM, which provided high accuracy but suffered from slow response times and high computational costs, or used only the SLMs, which were fast but often produced inconsistent or lower-quality results. In contrast, the parallel response generation and language model comparison system uniquely combines both approaches by simultaneously sending queries to the plurality of SLMs and the LLM, then using the LLM response as a quality benchmark to rank the faster SLM responses. This parallel processing approach, coupled with semantic similarity ranking, achieves both speed and accuracy. The parallel response generation and language model comparison system can generate responses in as little as 200-350 milliseconds through SLMs while maintaining quality standards comparable to more expensive LLM that typically take 1-2 seconds.

The parallel response generation and language model comparison system also addresses the resource intensity problem of traditional systems. While conventional LLM-only approaches require significant computational resources, the parallel response generation and language model comparison system uses a hybrid approach to handle high volumes of queries efficiently by primarily relying on lightweight SLMs while using the LLM as a quality control mechanism. This results in response delivery up to 80% faster than traditional LLM-only, making the parallel response generation and language model comparison system particularly valuable for real-time applications in customer support, educational platforms, and financial services where both speed and accuracy are crucial.

The system and method set forth herein address technical issues with generating the desired outputs described herein. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its(their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

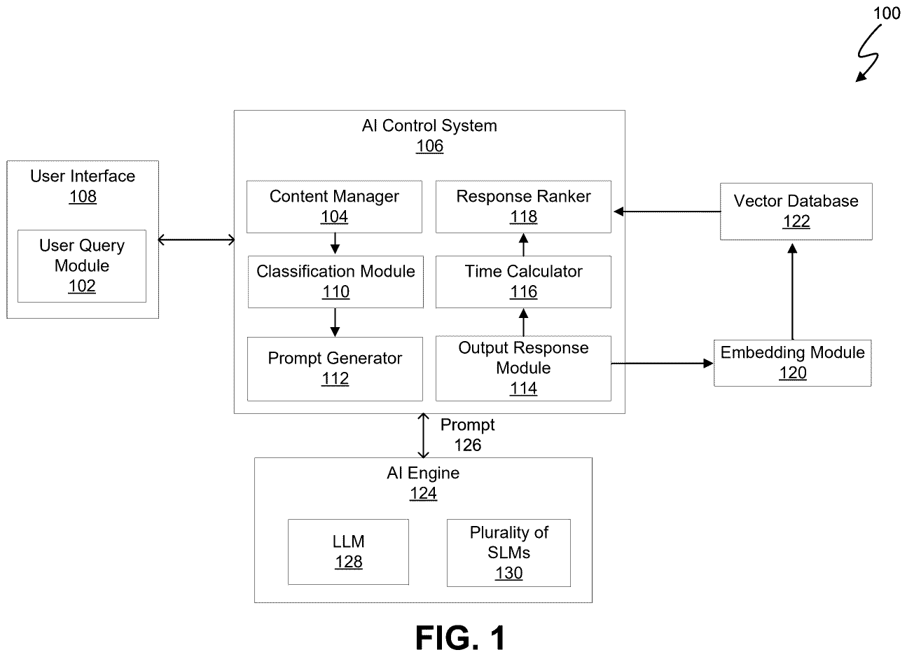

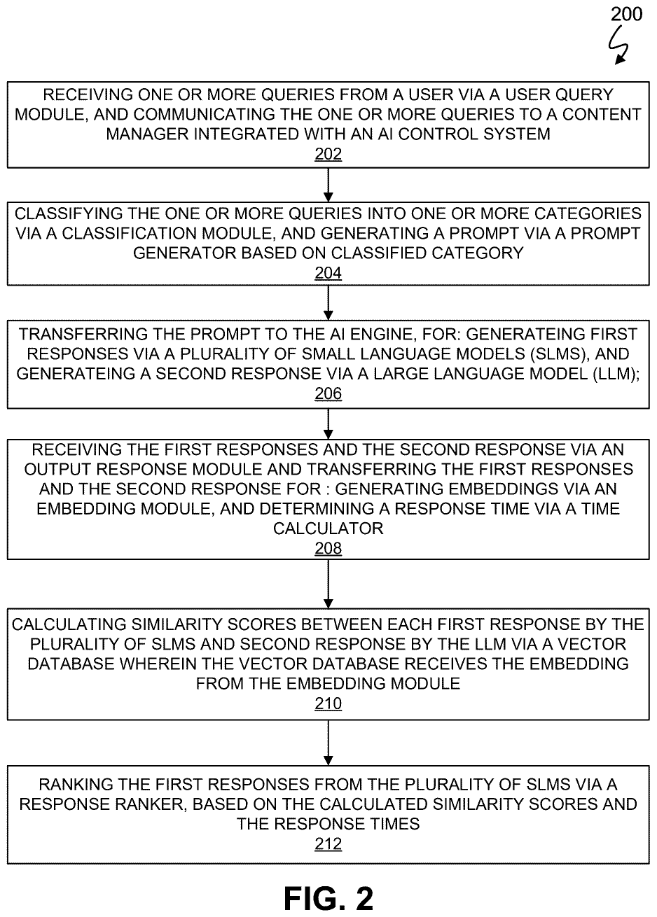

FIG. 1 depicts an exemplary parallel response generation and language model comparison system 100. FIG. 2 depicts an exemplary parallel response generation and language model comparison process 200 utilized by the parallel response generation and language model comparison system 100. Referring to FIGS. 1 and 2, in operation 202, a user query module 102 receives one or more queries from a user and communicates the one or more queries to a content manager 104 integrated with an AI control system 106. The user query module 102 acts as one of the user interface 108 components. The user query module 102 receives one or more queries from the users. The user query module 102 manages one or more queries receptions through a dedicated front-end interface while coordinating with the content manager 104 to prepare one or more queries for further processing. The one or more queries are the questions or requests from the user. In at least one embodiment the one or more queries accommodate various input types, including code generation requests, creative writing prompts, mathematical computations, financial analysis questions, etc.

The user interface 108 serves as the primary interaction point between the user and the AI control system 106. The user interface 108 captures queries through the integrated user query module 102. In at least one embodiment, the user interface 108 displays responses, status updates, and processing indicators. The user interface 108 also includes features to sort and filter responses based on different criteria like similarity scores and response times, helping the user easily find the most relevant or highest-quality responses from the system.

The AI control system 106 functions as the central command hub that orchestrates all interactions between different components of the parallel response generation and language model comparison system 100. The AI control system 106 includes the content manager 104, a classification module 110, a prompt generator 112, an output response module 114, a time calculator 116, and a response ranker 118. The AI control system 106 connects with external components such as an AI engine 124, an embedding module 120, and a vector database 122 to perform semantic analysis and similarity calculations.

In at least one embodiment, the AI control system 106 implements functionality primarily through Python or JavaScript. Python provides written instructions for computer tasks, while JavaScript enables interactive features in web browsers and servers for web applications. The content manager 104 facilitates the content flow between the different user query modules 102 and the AI control system 106. The control manager fetches the one or more queries received by the user query module 102 and integrates them with the AI control system 106.

In at least one embodiment, the content manager 104 fetches the one or more queries from the user interface 108 through AJAX/Fetch API calls for asynchronous HTTP requests, event listeners that capture user interactions, or WebSocket connections for real-time data streaming. The AJAX/Fetch API enables browsers to send HTTP requests to servers and receive responses without refreshing the entire webpage, creating smooth user experiences through asynchronous communication. The event listeners actively monitor and respond to user interactions like clicks, key presses, mouse movements, form submissions, and input changes by executing predefined callback functions. The event listeners use JavaScript code that captures events in real-time and triggers specific actions, such as collecting form data, validating input values, making API calls, or updating the user interface 108 dynamically based on the interaction type. The WebSocket connections establish a persistent, two-way communication channel between the user interface 108 and the AI control system 106, enabling instant data transmission without repeated HTTP requests.

For example, when a user submits a query such as “generate a story about a mouse in a house” through the user interface 108, the user query module 102 immediately captures this input and transfer into the content manager 104 integrated with the AI control system 106. In operation 204, the classification module 110 classifies the one or more queries into one or more categories via, and the prompt generator 112 generates a prompt 126 based on the classified categories.

The classification module 110 classifies one or more queries, such as code generation, financial analysis, creative writing, or mathematical computation and selects a prompt schema based on a category from one or more categories. The classification module 110 analyzes and sorts one or more queries into one or more categories, such as code generation, financial analysis, creative writing, and mathematical computation. In at least one embodiment, the classification module 110 examines the one or more queries and intent of one or more queries through natural language processing or python code to determine its appropriate category. Based on the one or more categories, the classification module 110 selects the most suitable prompt schema that aligns with the one or more queries identified one or more categories. The schema is then transferred into the prompt generator 112 for generating the prompt 126. The one or more categories represents a distinct area of functionality or expertise, such as code generation for programming-related requests, financial analysis for business and economic queries, creative writing for narrative and artistic content, and mathematical computation for numerical problem-solving.

The prompt schema is a predefined template with specific patterns, rules, and guidelines for the AI engineer. The prompt schemas are created by the prompt engineers and fed into classification module 110 so when the classification module 110 needs any prompt schema, then the prompt schema can be accessed. The prompt schema shapes the input to the AI engine 124 in a consistent format that the AI engine 124 can effectively interpret and respond. In at least one embodiment, the prompt schema includes essential components such as context markers, instruction patterns, and response formats tailored to different types of queries. For example, a code generation prompt schema includes sections for language specification, functionality requirements, and output format preferences, while a creative writing schema can include structure elements such as tone, style, and narrative perspective.

The prompt generator 112 constructs the prompt 126 based on the prompt schema by integrating one or more queries to the selected prompt schema. The prompt generator 112 receives one or more queries and the selected prompt schema from the classification module 110. The prompt generator 112 extracts key elements from one or more queries, such as parameters, requirements, and specifications. The prompt generator 112 inserts these extracted elements into designated slots within the prompt schema to create the prompt 126 for the AI engine 124. Prompt 126 represents multiple prompts used to guide and constrain the AI engine 124 to support the parallel response generation and language model comparison system 100 and parallel response generation and language model comparison process 200. Appendix A sets forth exemplary prompts 126, which are relevant to exemplary core behavior as described herein.

In operation 206, the prompt 126 is transferred to the AI engine 124 for: generating first responses via the plurality of SLMs 130 and generating a second response via the LLM 128. The AI engine 124 is a software system that processes data and performs complex computational tasks to simulate aspects of human intelligence. The AI engine 124 comprises the plurality of SLMs 130 and the LLM 128. In at least one embodiment, the AI engine 124 combines various components, including machine learning algorithms, neural networks, and data processing modules, to analyze inputs, recognize patterns, make decisions, and generate outputs. The AI engine 124 receives the prompt 126, transforms the prompt 126 through multiple layers of processing, and produces a response based on its trained models and programmed rules. In at least one embodiment, the AI engine 124 incorporates advanced techniques such as deep learning, natural language processing, and computer vision to handle diverse tasks such as text generation, image recognition, and decision-making. The AI engines 124 continuously refine the performance through feedback loops and optimization processes.

The plurality of SLMs 130 is streamlined artificial neural networks designed for natural language processing tasks, containing significantly fewer parameters than their larger counterparts, typically ranging from a few million to a few billion parameters. The plurality of SLMs 130 represent a more efficient and accessible approach to AI language processing, making the plurality of SLMs 130 suitable for deployment on devices with limited computational resources such as smartphones, edge devices, or personal computers. The plurality of SLMs 130 are specifically engineered to balance performance with efficiency, often specializing in focused tasks such as text classification, sentiment analysis, or domain-specific text generation.

The parallel response generation and language model comparison system includes the plurality of SLMs 130 such as LLaMA-2-7B, Mistral 7B, Phi-2, MobileBERT, TinyBERT, GPT-2 Small, RedPajama-1B, BLOOM-1B1, MPT-7B, DistilGPT2, and BERT-tiny, etc. The plurality of SLMs 130 receives the prompt 126 simultaneously and generates a first responses. The first responses include the response generated by the plurality of SLMs 130 which is integrated to the AI engine 124. The plurality of SLMs 130 work by processing text through multiple layers of neural networks that have been extensively compressed and optimized. The plurality of SLMs 130 achieve the compact size through various techniques such as knowledge distillation (where a larger model teaches a smaller one), pruning (removing less important neural connections), and quantization (reducing the precision of numerical representations). During operation, the plurality of SLMs 130 models convert input text into numerical representations, process the numerical representations through compressed neural networks, and generate appropriate outputs based on their training.

In at least one embodiment, the LLM 128 is an artificial intelligence system trained on vast amounts of text data to understand, generate, and manipulate human language. The LLM 128, built using deep learning architectures primarily based on the transformer mechanism, processes text by breaking it down into tokens and analyzing the relationships between words and phrases across multiple layers of neural networks. The LLM 128 learns patterns, context, and semantic relationships from their training data, which typically includes books, websites, articles, code repositories, and other text sources from the internet and digital archives. In the parallel response generation and language model comparison system, the LLM 128 generates a second response based on the prompt transferred from the AI control system 106. The LLM 128, after generating the second response, transfers the second response to the output response module 114.

In at least one embodiment, LLM 128 operation involves two phases: pre-training and inference. During the pre-training, the LLM 128 learns general language understanding through tasks like predicting the next word in a sequence or filling in masked words, using billions or even trillions of parameters to capture language patterns. During the inference (when the LLM 128 is actually used), the LLM 128 processes input text through its layers of attention mechanisms, where each layer examines different aspects of the text's meaning and relationships. The LLM 128 then generates responses by predicting the most probable next tokens based on its training and the input context, creating coherent and contextually appropriate text. In at least one embodiment, one LLM 128 is selected by the parallel response generation and language model comparison system from these: OpenAI's GPT-4 and GPT-3.5 (which powers ChatGPT), Anthropic's Claude 3 series (Opus, Sonnet, and Haiku), Google's Gemini series (Ultra, Pro, and Nano), and PaLM 2. Meta has Llama 2 in various sizes (70B, 34B, and 13B parameters), while Mistral AI offers models such as Mixtral 8×7B and Mistral Medium.

In operation 208, the output response module 114 receives the first responses and the second response and transfers the first responses and the second response to the embedding module 120 for generating embeddings, and the time calculator 116 for determining the response time. The output response module 114 serves as a coordinator that receives and processes responses from the plurality of SLMs 130 and the LLM 128. The output response module 114 collects the first responses generated by the plurality of SLMs 130 and the second response from the LLM 128. The output response module 114 routes the first responses and the second response to the embedding module 120 and the time calculator 116. The output response module 114 manages the synchronization of response processing, handling cases where responses arrive at different times while maintaining efficiency.

The output response module 114 transfers the first responses and the second response to the embedding module 120. When the embedding module 120 receives input, which includes the first responses and the second response from the AI engine 124, the embedding module 120 starts processing through the transformation pipeline. The embedding module 120 first preprocesses the discrete inputs, breaking down the first responses and the second response into appropriate chunks for vectorization. The embedding module 120 then converts these chunks into vector representations using specialized embedding algorithms and neural networks. The embedding module 120 functions as a text-to-vector converter that captures the semantic meaning of input from the output response module 114. When the input from the output response module 114 enters the embedding module 120, the embedding module 120 first tokenizes the content, breaking down sentences into individual words or subwords called tokens. For example, if the input is “machine learning applications,” the module splits it into “machine,” “learning,” and “applications.”

In at least one embodiment, the embedding module 120 converts the tokens into dense numerical vectors using trained neural networks. The numerical vectors typically contain hundreds or thousands of dimensions, where each dimension represents some learned semantic feature. For example, a 768-dimensional vector might capture aspects like “technical terminology,” “action words,” or “abstract concepts.” The embedding module 120 maps similar words close together in this high-dimensional space; words like “car” and “automobile” would have similar vector representations. For example, when processing first responses from the plurality of SLMs 130 about “sales performance in Q2,” the embedding module 120 generates a vector like [0.123, −0.456, 0.789, . . . ] with hundreds more numbers. The embedding module 120 maintains consistency in vector outputs by using the same trained model and dimension for all first responses and second response. In at least one embodiment, the embedding module 120 often employs pre-trained language models like BERT or similar architectures that have learned rich semantic representations from massive text corpora. The embedding module 120 fine-tunes the representations for specific domains and data types. For instance, if the first responses contain technical documentation detail, the embeddings will adapt to capture technical terminology and relationships more precisely.

In at least one embodiment, the embedding module 120 employs several methods to convert tokens into dense numerical vectors, such as Word2Vec leads the pack, using either Continuous Bag of Words (CBOW) or Skip-gram architectures to learn vector representations by predicting words from their context or vice versa. GloVe takes a different approach, building vectors by analyzing global word co-occurrence statistics in the corpus. FastText extends the embedding capability by breaking words into character N-grams, allowing the FastText to handle out-of-vocabulary words and morphologically rich languages. Doc2Vec expands on Word2Vec by adding document context to generate vectors for entire documents alongside individual words. The neural network learns these representations through backpropagation during training, adjusting the vectors to minimize the difference between predicted and actual word distributions in the training corpus. Each method produces vectors typically ranging from 100 to 1024 dimensions, where each dimension represents a learned feature of the word's meaning and usage patterns. In at least one embodiment, the embedding module 120 employs newer transformer-based models such as BERT, RoBERTa, or GPT that create dynamic, context-aware embeddings through their deep neural architectures.

The output response module 114 transfers the first responses and the second response to the time calculator 116. The time calculator 116 determines the response time by measuring a duration between receiving a first token and receiving a final token for each response from the first responses and the second response. For example, if a response begins with the token “the” at 1:00:00 PM and ends with the token “.” at 1:00:05 PM, the response time will be 5 seconds. The tokens are the individual units of text that make up a response; for example, words, parts of words, or even punctuation marks. The “First token” refers to the very beginning piece of the response, while the “final token” marks the end of the response.

In operation 210, the vector database 122 calculating similarity scores between each first responses by the plurality of SLMs and second response by the LLM via the vector database 122 wherein the vector database 122 receives the embedding from the embedding module 120. The vector database 122 functions as a storage and retrieval system that manages high-dimensional vector representations of data. The vector database 122 organizes and indexes these vectors in a way that enables rapid similarity searches and efficient nearest-neighbor queries. The vector database 122 in at least one embodiment employs sophisticated algorithms and data structures, such as LSH (Locality-Sensitive Hashing) or HNSW (Hierarchical Navigable Small World), to handle the complexities of vector operations. The vector database 122 excels at processing embeddings, which represent text, images, or other data types as numerical vectors, and can quickly find relationships between these vectors using distance metrics like cosine similarity or Euclidean distance. The parallel response generation and language model comparison system uses Pinecone as the vector database 122. The Pinecone is the cloud-based vector database 122 founded in 2019.

Examples of the vector database 122 are the pinecone, which specializes in machine learning applications and real-time vector search. Milvus, the open-source vector database 122 that handles large-scale similarity searches. Weaviate combines vector search with GraphQL integration. Qdrant, offering efficient vector similarity search with filtering capabilities. Faiss (Facebook AI Similarity Search), which excels at dense vector similarity search and clustering.

The vector database 122 performs similarity calculations between first responses and second response from the plurality of SLMs 130 and the LLM 128 respectively. The similarity calculation begins when the embedding module 120 generates embeddings of both the first responses and the second response. The embeddings capture the semantic meaning and key characteristics of each response in a high-dimensional vector space.

Upon receiving the embeddings from the embedding module 120, the vector database 122 initiates the similarity calculations process. The vector database 122, in at least one embodiment, employs algorithms to calculate similarity scores, typically using metrics such as cosine similarity or Euclidean distance. The algorithms measure how closely the vector representations of the first responses align with the vector representation of the second response in the multidimensional space. A higher similarity score indicates greater semantic and contextual alignment between the first responses and the second response. The vector database 122 executes these calculations systematically, comparing the plurality of SLM 130 response's embeddings against the LLM 128 response's embeddings. The similarity calculations generate a comprehensive set of similarity scores that quantify the relationship between each pair of responses.

In operation 212, the response ranker 118 ranks the first responses based on the calculated similarity scores and the response times. The response ranker 118 evaluates and orders the first responses from the plurality of SLMs 130 using two key metrics. The response ranker 118 analyzes both the similarity scores calculated from the embeddings and the response times measured by the time calculator 116. The response ranker 118 applies a weighting algorithm that balances the importance of response quality (indicated by similarity to the LLM 128 response) against response speed. For each SLM response, it combines these weighted metrics into a composite score. Using these composite scores, the response ranker 118 then sorts the responses in descending order, placing the most optimal responses—those that best balance similarity and speed—at the top of the list. This ranked output helps users quickly identify which SLMs 130 performed best for their specific query, considering both accuracy and efficiency. The response ranker 118 assigns weights to both the similarity scores from the vector database 122 and the response time from the time calculator 116.

The parallel response generation and language model comparison system 100 tracks the performance of each SLM over time, identifying which SLMs 130 consistently provide responses most similar to the LLM 128, and prioritizing those SLMs 130 in one or more future query processing. The parallel response generation and language model comparison system 100 monitors and records the performance metrics of each SLM 130 across multiple queries. The parallel response generation and language model comparison system 100 maintains a historical database that tracks similarity scores, response times, and other relevant metrics for each SLM 130. Through continuous analysis of the performance data, the parallel response generation and language model comparison system 100 identifies patterns and trends, determining which SLMs 130 consistently generate responses that closely align with the LLM 128 second response.

The method of claim 1, wherein presenting the ranked SLM responses includes displaying the SLM response having the highest similarity score to the LLM 128 response; providing an option to view alternative responses from other SLMs; and indicating the similarity score and response time for each displayed response. The parallel response generation and language model comparison system 100 presents the ranked SLM first responses through the user interface 108. The response ranker 118 prominently displays the top-performing SLM response either based on the similarity score or time taken. The user interface 108 provides the users with interactive options to explore alternative first responses generated by other SLMs 130, allowing them to compare different approaches or solutions.

Pseudocode for parallel response generation and language model comparison process:

```
function handleQuery(query):
  responses = sendToSLMs(query)
  llmResponse = sendToLLM(query)
  rankedResponses = rankResponses(responses, llmResponse)
  return selectTopResponse(rankedResponses)
function sendToSLMs(query):
  // Send query to all configured SLMs
  return [SLM1.response(query), SLM2.response(query), ...]
function sendToLLM(query):
  // Send query to LLM and return response
  return LLM.response(query)
function rankResponses(responses, benchmark):
  // Calculate closeness of each response to LLM response
  closenessScores = [calculateCloseness(response, benchmark) for
response in responses]
  // Sort responses based on closeness
  return sort(responses, closenessScores)
function calculateCloseness(response, benchmark):
  // Implement semantic analysis to determine closeness
  return cosineSimilarity(response.vector, benchmark.vector)
function selectTopResponse(rankedResponses):
  // Select the top-ranked response
  return rankedResponses[0]
```

The above-mentioned pseudocode outlines the parallel response generation and language model comparison processes 200. The user sends one or more queries to the plurality of SLMs 130 and the LLM 128 in parallel through the AI control system 106. The AI control system 106 collects the first responses and the second response from the plurality of SLMs 130 and the LLM 128, respectively. The parallel response generation and language model comparison processes 200 then evaluate each of the first responses by calculating semantic similarity to the second response using cosine similarity between the vector representations. A ranking algorithm sorts the first responses based on the closeness scores to the second response. Finally, the parallel response generation and language model comparison process selects 200 selects and returns the highest-ranked first responses, which represents the plurality of SLMs 130 output that most closely aligns with the LLM 128 second response.

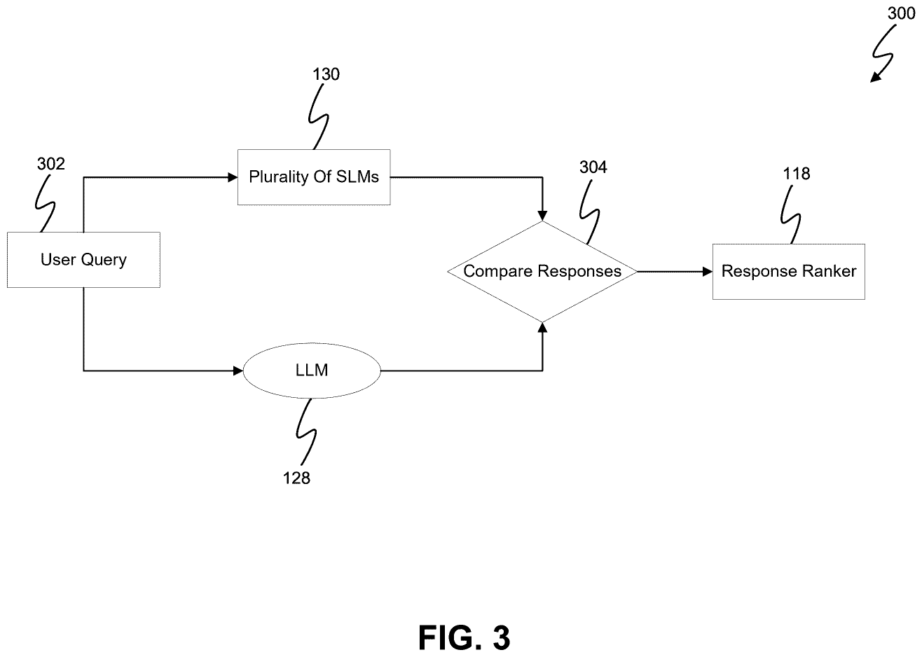

FIG. 3 depicts the process flow 300, which is an embodiment of parallel response generation and language model comparison processes. The process flow 300 begins with a user query 302. The user query 302 is given to the AI control system 106. The AI control system 106 transfers the user query 302 to the plurality of SLMs 130 and the LLM 128. A compare response stage 304 receives the first responses and the second response from both the plurality of SLMs 130 and the LLM 128 respectively, where the parallel response generation and language model comparison system 100 evaluates and compares the first responses and second response by using the vector database 122 and the time calculator 116. Finally, the response ranker 118 receives response time and similarity score from the time calculator 116 and the vector database 122, respectively and calculates the composite response score.

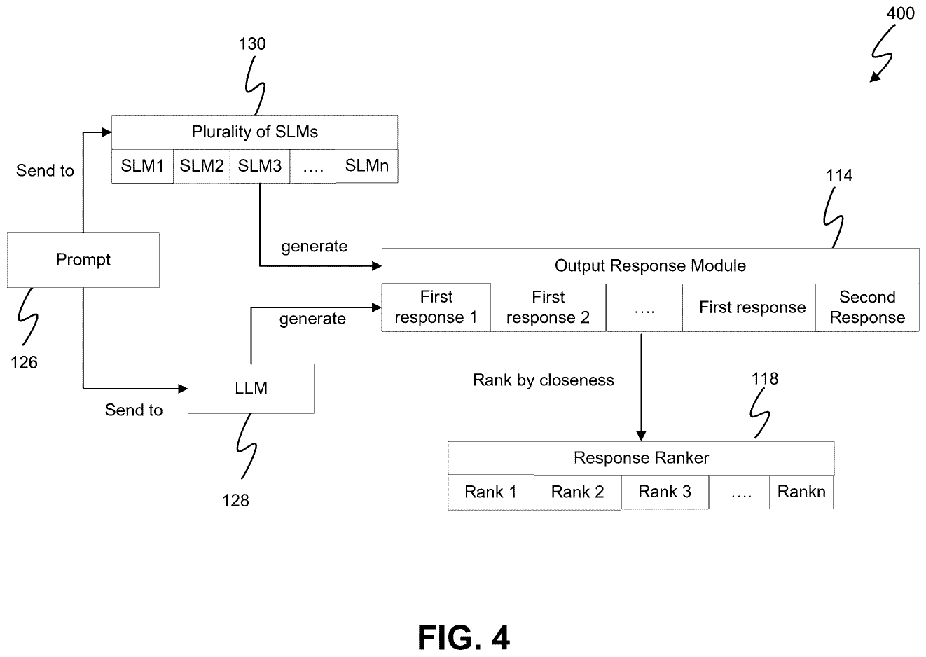

FIG. 4 depicts a data flow 400, which is an embodiment of parallel response generation and language model comparison process. The prompt 126 simultaneously sends input to the plurality of SLMs 130, such as SLM1, SLM2, SLM3, etc., and to the LLM 128. The output response module 114 collects the first responses, which includes response 1, response 2, response 3, etc., from the plurality of SLMs 130, 130 and the second response from the LLM 128. The output response module 114 transfers the first responses and the second response to the time calculator 116 and the vector database 122 through the embedding module 120 for similarity calculation. The response ranker 118 receives the similarity score and calculates the composite response score.

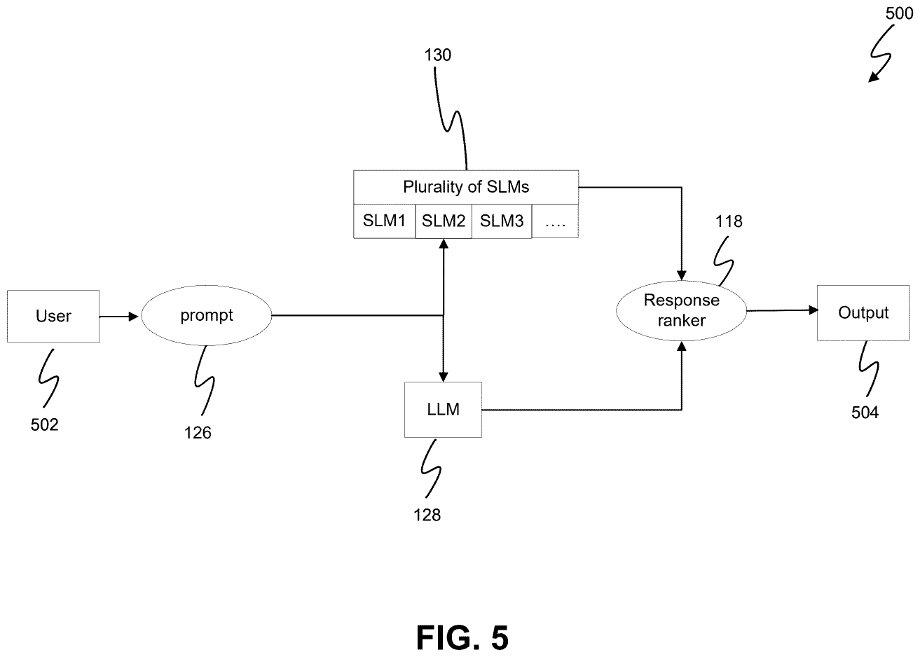

FIG. 5 depicts flow from the user through the plurality of SLMs 130 and the LLM 128, for the ranking of responses 500, which is an embodiment of parallel response generation and language model comparison process. A user 502 initiates the parallel response generation and language model comparison process 200 by sending input such as one or more queries. The prompt generator 112 integrated into the AI control system 106 generates the prompt 126 with respect to the input data. The prompt 126 is transferred to the plurality of SLMs 130, such as SLM1, SLM2, SLM3, etc., and to the LLM 128. The output response module 114 collects the first responses from the plurality of SLMs 130 and the second response from the LLM 128. The output response module 114 transfers the first responses and the second response to the time calculator 116 and the vector database 122 for response time calculation and similarity score calculation. The response ranker 118 receives the response time and similarity score and calculates the composite response score. The response ranker gives an output of 504 through the user interface 108.

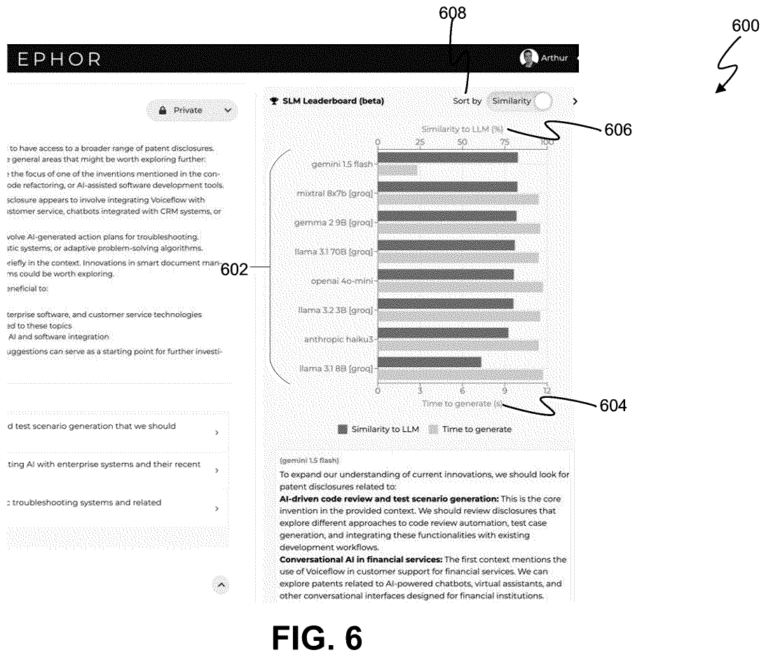

FIG. 6 depicts the response comparison of different language models 600, which is an embodiment of parallel response generation and language model comparison process. The first responses comparison with the second response is presented as a dual-bar chart. The language models 602 are listed vertically. The metrics of comparison, which include time to generate 604 and similarity to LLM 606, extend horizontally. The language models 602 include Gemini 1.5 Flash, Mixtral 8×7b, Gemma 2 9B, Llama 3.1 70B, Anthropic Haiku3 and Llama 3.1 8B. The interface of response comparison of different language models 600 also includes the option to sort 608, where the user can sort 608 the composite response score based on the similarity or time taken to generate.

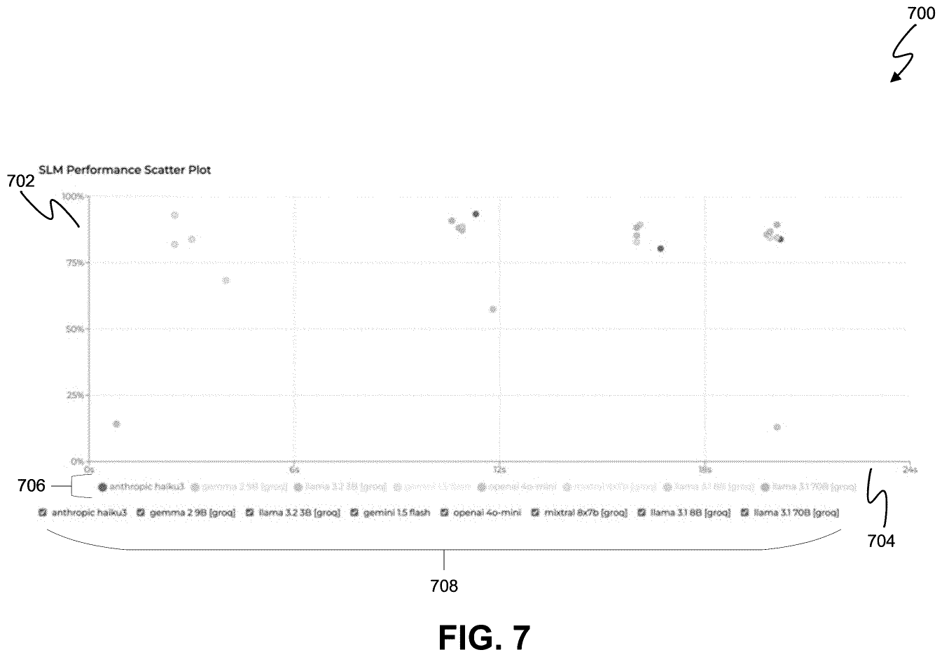

FIG. 7 depicts the performance scatter plot by a user interface 700, which is an embodiment of parallel response generation and language model comparison process. The scatter plot displays the plurality of SLMs 130 performance data. The y-axis 702 shows the first responses similarity to the second response generated by the LLM 128 in percentages from 0% to 100%. The x-axis 704 is to measure the time taken to generate the first responses. Legend 706 represents the list of the plurality of SLMs 130 first responses used for the comparison. Legend 708 enhances user control by providing the flexibility to select which SLM 130 responses to include. The user can easily customize their experience by checking or unchecking boxes for each model. For instance, if the user prefers to exclude Anthropic Haiku3's responses, the user can simply untick its corresponding checkbox, allowing them to focus on the specific models that best suit their needs.

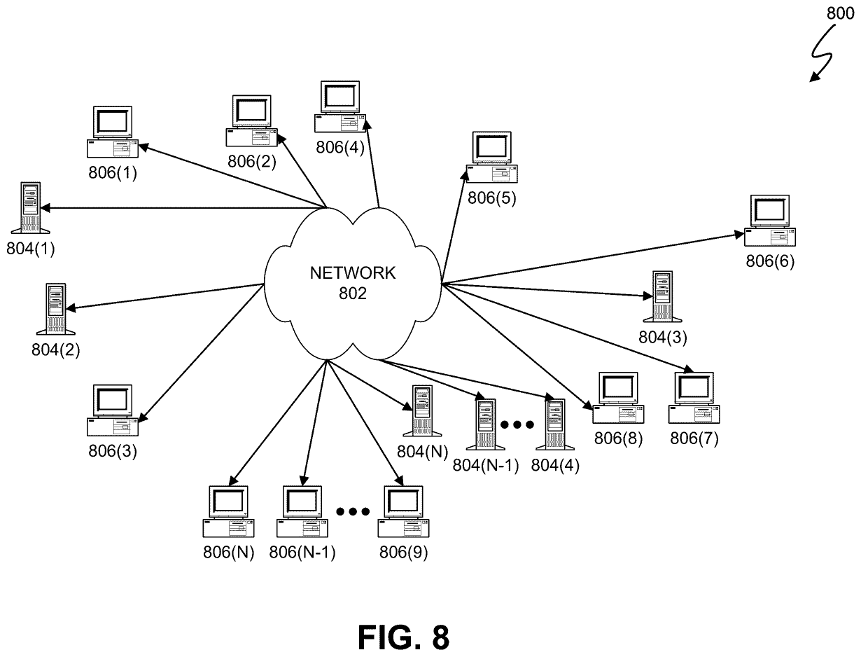

FIG. 8 is a block diagram illustrating a network environment in which a parallel response generation and language model comparison system 100 and a process 200 may be practiced. Network 802 (e.g. a private wide area network (WAN) or the Internet) includes a number of networked server computer systems 804(1)-(N) that are accessible by client computer systems 806(1)-(N), where N is the number of server computer systems connected to the network. Communication between client computer systems 806(1)-(N) and server computer systems 804(1)-(N) typically occurs over a network, such as a public switched telephone network over asynchronous digital subscriber line (ADSL) telephone lines or high-bandwidth trunks, for example communications channels providing T1 or OC3 service. Client computer systems 806(1)-(N) typically access server computer systems 804(1)-(N) through a service provider, such as an internet service provider (“ISP”) by executing application specific software, commonly referred to as a browser, on one of client computer systems 806(1)-(N).

Client computer systems 806(1)-(N) and/or server computer systems 804(1)-(N) are specialized computer programmed to improve conventional computer systems to implement and utilize the parallel response generation and language model comparison system 100 and the process 200. The type of computer system that can be specially programmed to implement and utilize the parallel response generation and language model comparison system 100 and the process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the parallel response generation and language model comparison system 100 and the process 200 can be implemented using code stored in a tangible, non-transient computer readable medium and executed by one or more processors. In at least one embodiment, the parallel response generation and language model comparison system 100 and the process 200 can be implemented completely in hardware using, for example, logic circuits and other circuits including field programmable gate arrays.

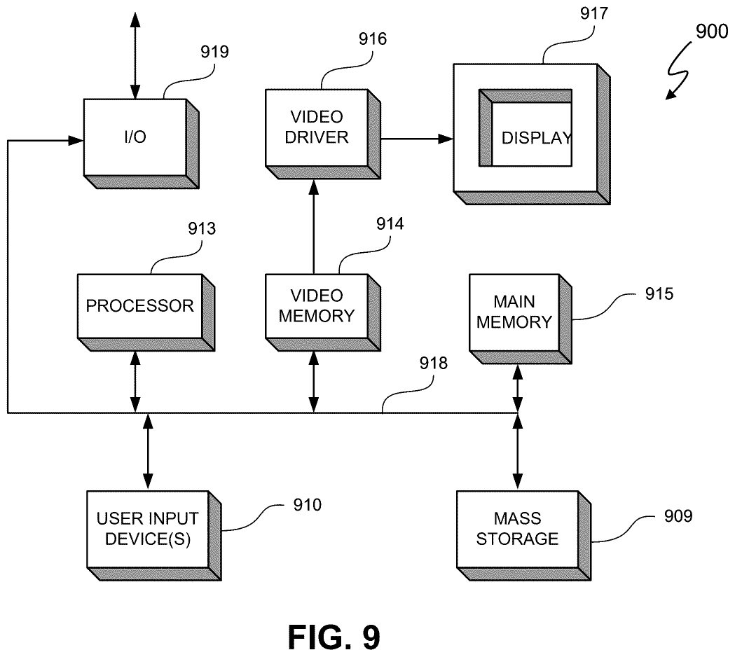

Embodiments of the parallel response generation and language model comparison system 100 and the process 200 can be implemented on a computer system such as a special-purpose, special-programmed computer 900 illustrated in FIG. 9. Input user device(s) 910, such as a keyboard and/or mouse, are coupled to a bi-directional system bus 918. The input user device(s) 910 are for introducing user input to the computer system and communicating that user input to processor 913. The computer system of FIG. 9 generally also includes a non-transitory video memory 914, non-transitory main memory 915, and non-transitory mass storage 909, all coupled to bi-directional system bus 918 along with input user device(s) 910 and processor 913. The mass storage 909 may include both fixed and removable media, such as a hard drive, one or more CDs or DVDs, solid state memory including flash memory, and other available mass storage technology. Bus 918 may contain, for example, 32 of 64 address lines for addressing video memory 914 or main memory 915. The system bus 918 also includes, for example, an n-bit data bus for transferring DATA between and among the components, such as CPU 909, main memory 915, video memory 914 and mass storage 909, where “n” is, for example, 32 or 64. Alternatively, multiplex data/address lines may be used instead of separate data and address lines.

I/O device(s) 919 may provide connections to peripheral devices, such as a printer, and may also provide a direct connection to a remote server computer systems via a telephone link or to the Internet via an ISP. I/O device(s) 919 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 909, into main memory 915 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 913, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 915 is comprised of dynamic random access memory (DRAM). Video memory 914 is a dual-ported video random access memory. One port of the video memory 914 is coupled to video amplifier 916. The video amplifier 916 is used to drive the display 917. Video amplifier 916 is well known in the art and may be implemented by any suitable means. This circuitry converts pixel DATA stored in video memory 914 to a raster signal suitable for use by display 917. Display 917 is a type of monitor suitable for displaying graphic images.

The computer system described above is for purposes of example only. The parallel response generation and language model comparison system 100 and the process 200 may be implemented in any type of computer system or programming or processing environment. It is contemplated that the parallel response generation and language model comparison system 100 and the process 200 might be run on a stand-alone computer system, such as the one described above. The parallel response generation and language model comparison system 100 and the process 200 might also be run from a server computer systems system that can be accessed by a plurality of client computer systems interconnected over an intranet network. Finally, the parallel response generation and language model comparison system 100 and the process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for comparing a plurality of first responses generated by small language models (SLMs) with a second response generated by a large language model (LLM) to generate a performance-based ranking comprising:
executing code using one or more processors of a computer system to cause the computer system to perform operations comprising:
receiving one or more queries from a user via a user query module, and communicating the one or more queries to a content manager integrated with an AI control system;
classifying the one or more queries into one or more categories via a classification module, and generating a prompt via a prompt generator based on a classified category;
transferring the prompt to an AI engine, for:
generating the first responses via the plurality of SLMs, and
generating the second response via the LLM;
receiving the first responses and the second response via an output response module and transferring the first responses and the second response for:
generating embeddings via an embedding module, and
determining a response time via a time calculator;
calculating similarity scores between each first responses by the plurality of SLMs and second response by the LLM via a vector database wherein the vector database receives the embedding from the embedding module; and
ranking the first responses from the plurality of SLMs via a response ranker, based on the calculated similarity scores and the response times.

2. The method of claim 1, wherein the classification module classifies the one or more queries, such as code generation, financial analysis, creative writing, or mathematical computation and selects a prompt schema based on a category from one or more categories.

3. The method of claim 1, wherein the prompt generator constructs the prompt based on the prompt schema by integrating one or more queries into the selected prompt schema.

4. The method of claim 1, wherein the vector database performs semantic analysis between chunks of the first responses by the plurality of SLMs and chunks of the second response by the LLM and aggregates chunk-level similarity scores to generate an overall similarity score for the first responses by the plurality of SLMs.

5. The method of claim 1, wherein the response ranker assigns weights to both the similarity scores and response times and calculates a composite response score.

6. The method of claim 1 further comprises tracking the performance of each SLM over time, identifying which SLMs consistently provide responses most similar to the LLM, and prioritizing those SLMs in one or more future query processing.

7. The method of claim 1, wherein presenting the ranked first responses includes displaying the first responses having the highest similarity score to the second response, providing an option to view alternative first responses from other SLMs, and indicating the similarity score and response time for each the displayed first responses.

8. The method of claim 1, wherein the first responses include the response made by the plurality of SLMs and the second response includes the response made by the LLM.

9. The method of claim 1, wherein the prompt generator transfers the prompt simultaneously to the plurality of SLMs and the LLM integrated within the AI engine.

10. The method of claim 1, wherein the time calculator determines a response time by measuring the duration between receiving a first token and receiving a final token from each first responses.

11. A system for comparing a plurality of first responses generated by small language models (SLMs) with a second response generated by a large language model (LLM) to generate a performance-based ranking comprising:
one or more processors of a computer system;
memory, coupled to the one or more processors, that stores code and execution of the code by the one or more processors causes the computer system to perform operations comprising:
receiving one or more queries from a user via a user query module, and communicating the one or more queries to a content manager integrated with an AI control system;
classifying the one or more queries into one or more categories via a classification module, and generating a prompt via a prompt generator based on a classified category;
transferring the prompt to an AI engine, for:
generating the first responses via the plurality of SLMs, and
generating the second response via the LLM;
receiving the first responses and the second response via an output response module and transferring the first responses and the second response for:
generating embeddings via an embedding module, and
determining a response time via a time calculator;
calculating similarity scores between each first responses by the plurality of SLMs and second response by the LLM via a vector database wherein the vector database receives the embedding from the embedding module; and
ranking the first responses from the plurality of SLMs via a response ranker, based on the calculated similarity scores and the response times.

12. The system of claim 11, wherein the classification module classifies the one or more queries, such as code generation, financial analysis, creative writing, or mathematical computation and selects a prompt schema based on a category from one or more categories.

13. The system of claim 11, the prompt generator, constructs the prompt based on the prompt schema by integrating one or more queries into the selected prompt schema.

14. The system of claim 11, wherein the vector database performs semantic analysis between chunks of the first responses by the plurality of SLMs and chunks of the second response by the LLM and aggregates chunk-level similarity scores to generate an overall similarity score for the first responses by the plurality of SLMs.

15. The system of claim 11, wherein the response ranker assigns weights to both the similarity scores and response times and calculates a composite response score.

16. The system of claim 11 further comprises tracking the performance of each SLM over time, identifying which SLMs consistently provide responses most similar to the LLM, and prioritizing those SLMs in one or more future query processing.

17. The system of claim 11, wherein presenting the ranked first responses includes displaying the first responses having the highest similarity score to the second response; providing an option to view alternative first responses from other SLMs; and indicating the similarity score and response time for each the displayed first responses.

18. The system of claim 11, wherein the first responses include the response made by the plurality of SLMs and the second response includes the response made by the LLM.

19. The system of claim 11, the prompt generator, transfers the prompt simultaneously to the plurality of SLMs and the LLM integrated within the AI engine.

20. The system of claim 11, wherein the time calculator determines a response time by measuring the duration between receiving a first token and receiving a final token from each first responses.
